(19) United States
(12) Patent Application Publication
(10) Pub. No.: US 2003/0236689 A1
(43) Pub. Date: Dec. 25, 2003

(54) Analyzing decision points in business processes

(76) Inventors: Fabio Casati, Palo Alto, CA (US); Mehmet Sayal, Sunnyvale, CA (US); Maria Guadalupe Castellanos, Sunnyvale, CA (US); Dimitrios Gunopulos, Riverside, CA (US)

Correspondence Address: HEWLETT-PACKARD COMPANY, Intellectual Property Administration, P.O. Box 272400, Fort Collins, CO, 80527-2400, US

(21) Appl. No.: 10/177,423

(22) Filed: Jun. 21, 2002

(51) Int. Cl. G06F 17/60

(52) U.S. Cl. 705/7

(57) ABSTRACT

Systems and methods of analyzing decision points in a business process are described. In one aspect, process execution data that is generated by a workflow management system during execution of one or more instances of a business process involving a set of one or more activities and a set of one or more decision points is accessed. Based upon the accessed process execution data, a predictive quantitative model including a set of one or more rules correlating context data at different stages of the business process with business process outcomes at one or more decision points in the business process is built. In another aspect, one or more rules correlating context data at different stages of the business process with business process outcomes at one or more decision points in the business process are presented to a user.

### CROSS-REFERENCE TO RELATED APPLICATIONS

This application relates to the following co-pending applications, each of which is incorporated herein by reference: U.S. patent application No. 09/860,230, filed May 17, 2001, by Fabio Casati et al. and entitled “Method of Identifying and Analyzing Business Processes from Workflow Audit Files;” U.S. patent application No. ______, filed ______, by Fabio Casati et al. and entitled “Investigating Business Processes” [Attorney Docket No. 10019712-1]; U.S. patent application No. ______, filed ______, by Fabio Casati et al. and entitled “Improving Business Processes” [Attorney Docket No. 10019713-1].

### TECHNICAL FIELD

This invention relates to systems and methods of analyzing decision points in business processes.

### BACKGROUND

Competitive pressures are forcing organizations to integrate and automate their business operations, such as order processing, procurement, claims processing, and administrative procedures. As a result, process design, automation, and management technologies are being used in both traditional and newly-formed, Interned-based enterprises in order to improve the quality and efficiency of their administrative and production processes, to manage electronic commerce (or e-commerce) transactions, and to rapidly and reliably deliver services to businesses and individual customers.

Electronic business (or e-business) is implemented by business processes that enable information to be accessed, updated and communicated in a purely digital format. E-business is transforming corporations, markets, and the global economy. The conduct of business over Internet (e.g., buying, selling, servicing customers and collaborating with business partners) is affecting how business transactions are performed. For example, web services allow customers to easily find products, services, providers and suppliers that they need, compare prices and qualities, and trade, buy, and get products and services delivered quickly. Customers may be presented with user-friendly graphical interfaces, targeted advertisements, up-to-date product catalogues, and personalized stores. The web facade, however, hides inefficiencies, manual and error-prone operations, and slow, complex, inflexible, and unmanageable systems. Indeed, in many e-business applications, the execution of business processes involves a substantial amount of human intervention in several aspects of business process execution, such as (repeated) data entry, process execution monitoring (a process that often requires tracking each process over several systems in order to find out its current advancement state), exception handling, and scheduling of process activities.

Inefficiencies in e-business processes impose high operating costs that are strongly affecting the profits of many e-business entities. To compete successfully, enterprises are demanding effective ways to implement e-business and deliver e-services over the Internet. In order to attract and retain customers as well as business partners, organizations also need to provide their services (i.e., execute their processes) with a high, consistent, and predictable quality. In general, in order to deliver such quality, business processes should be designed correctly, their execution should be supported by a system that can meet workload requirements, and the (human or automated) process resources should be able to perform their work items in a timely fashion.

### SUMMARY

The invention features systems and methods of analyzing decision points in a business process.

In one aspect of the invention, process execution data that is generated by a workflow management system during execution of one or more instances of a business process involving a set of one or more activities and a set of one or more decision points is accessed. Based upon the accessed process execution data, a predictive quantitative model comprising a set of one or more rules correlating context data at different stages of the business process with business process outcomes at one or more decision points in the business process is built.

In another aspect, the invention features a computer program for analyzing decision points in a business process. The computer program resides on a computer-readable medium and comprises computer-readable instructions for causing a computer to implement the above-described business process decision point analysis method.

In another aspect of the invention, one or more rules correlating context data at different stages of the business process with business process outcomes at one or more decision points in the business process are presented to a user.

In another aspect, the invention features a system comprising a graphical user interface configured to present to a user one or more rules correlating context data at different stages of the business process with business process outcomes at one or more decision points in the business process.

Other features and advantages of the invention will become apparent from the following description, including the drawings and the claims.

### DESCRIPTION OF DRAWINGS

FIG. 1 is diagrammatic view of an e-business driven infrastructure that includes service providers, customers and employees that are interconnected by a global communication network.

FIG. 2 is a diagrammatic view of a process entity space.

FIG. 3 is a workflow diagram of an expense approval process.

FIG. 4 is a diagrammatic view of a business process platform supporting execution of internal electronic interactions within a domain of a business entity and managing external electronic interactions between the business entity and a plurality of external entities.

FIG. 5 is a block diagram of a system for investigating a business process that includes a business operational intelligence engine that is operable to build a business process data warehouse by populating a database with service execution data generated by one or more components of the business process platform of FIG. 4.

FIG. 6 is a block diagram of internal components of the business operational intelligence engine and the business process data warehouse that are shown in FIG. 5.

FIG. 7 is a flow diagram of a method of analyzing decision points in a business process.

FIG. 8A is a flow diagram of a method of building a predictive quantitative model that includes a set of rules correlating context data at different stages of a business process with business process outcomes at one or more decision points in the business process.

FIG. 8B is a diagrammatic view of a set of rules specifying outcome probabilities at decision points each conditioned on completion of all activities up to a given stage of the business process and a given context data value.

FIG. 9 is a directed graph corresponding to a process definition that includes activities and decision points in a product purchase request process and a correlation rule identified by the method of FIGS. 8A and 8B.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

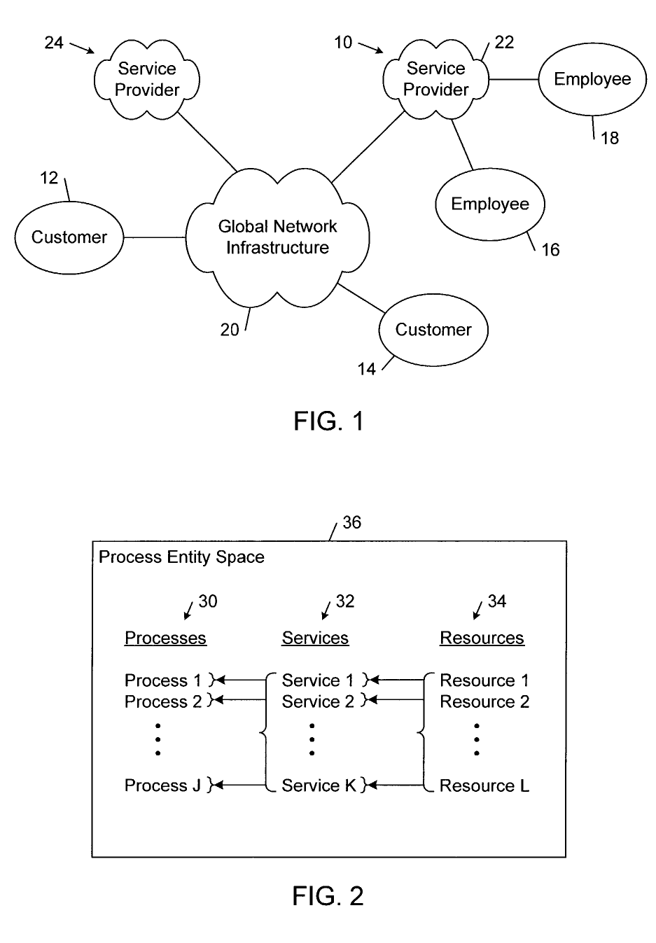

Referring to FIG. 1, in one embodiment, a service provider 10 may deliver one or more services to customers 12, 14 and employees 16, 18 over a global communication network 20 and a service provider network 22. In order to deliver such services, service provider 10 executes processes and functions that may require the use of several resources and the invocation of other services, possibly offered by one or more remote service providers 24. For example, to deliver an e-procurement service, service provider 10 may invoke (web or traditional) services provided by suppliers, warehouses, and shipment companies, as well as services provided by internal (human or automated) resources, such as administrative employees, ERP (Enterprise Resource Planning) systems, Java beans, implementation of WSDL (Web Service Description Language) services, and printers.

Global communication network 20 may include a number of different computing platforms and transport facilities, including a voice network, a wireless network, and a computer network. Service requests may be transmitted, and service replies may be presented in a number of different media formats, such as voice, Internet, e-mail and wireless formats. In this way, customers 12, 14 may access the services provided by service provider 10 using any one of a wide variety of different communication devices. For example, in one illustrative implementation, a wireless device (e.g., a wireless personal digital assistant (PDA)) may connect to service provider 10 over a wireless network. Communications from the wireless device may be in accordance with the Wireless Application Protocol (WAP). A wireless gateway converts the WAP communications into HTTP messages that may be processed by service provider 10. In another illustrative implementation, a voice device (e.g., a conventional telephone) may connect to service provider 10 over a voice network. Communications from the voice device may be in the form of conventional analog or digital audio signals, or they may be formatted as VoxML messages. A voice gateway may use speech-to-text technology to convert the audio signals into HTTP messages; VoxML messages may be converted to HTTP messages based upon an extensible style language (XSL) style specification. The voice gateway also may be configured to receive from service provider 10 real time audio messages that may be passed directly to the voice device. Alternatively, service provider 10 may transmit formatted messages (e.g., VoxML, XML, WML, e-mail) that must be converted to a real time audio format (e.g., using text-to-speech technology) before the messages may be passed to the voice device. In a third illustrative implementation, a software program operating at a client personal computer (PC) may access the services of service provider 10 over the Internet.

Referring to FIG. 2, the services provided by service provider 10 may be built from a collection of business process entities, including processes 30, services 32, and resources 34. In particular, any given service may be defined by a directed graph of business processes 30. Each process 30 is operable to invoke one or more services 32 for carrying out a specified activity. Each service 32 specifies the way in which a particular activity should be performed. Each service 32 is operable to invoke one or more resources 34, each of which performs an activity in accordance with the service specification. Each resource 34 may be invoked by one more services 32, and each service 32 may be invoked by one or more processes 30. In the context of process entity space 36, each business process 30 may be visualized along multiple dimensions and multiple levels of granularity based upon the mappings between the business process and its associated services and resources.

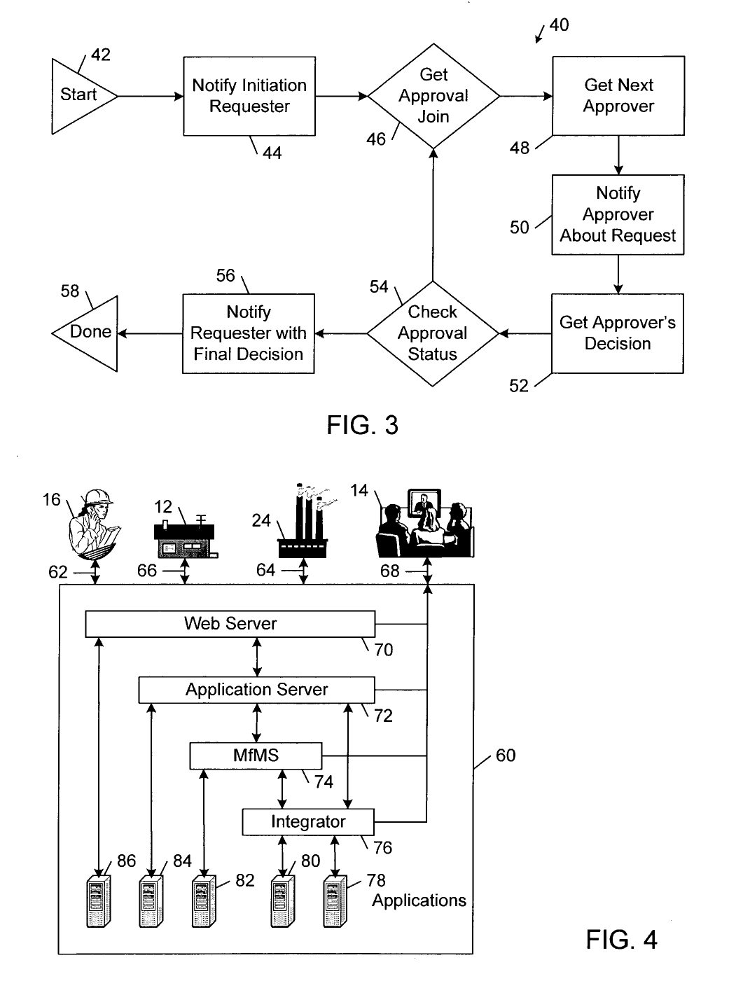

As shown in FIG. 3, a business process may be modeled as a directed graph 40 having at least four types of nodes including work nodes, route nodes, start nodes, and completion nodes. A work node represents the invocation of a service (or activity). Each work node is associated with a service description that defines the logic for selecting a resource or resource group to be invoked for executing the work. The service definition also identifies the case packet data items to be passed to the resource upon invocation (e.g., execution parameters or input data) and to be received from the resource upon completion of the work (e.g., status values, output data). Several work nodes may be associated to the same service description. Route nodes are decision points that control the execution flow among nodes based on a routing rule. A start node denotes the entry point to the process, and completion nodes denote termination points. A process definition may be instantiated several times and multiple instances may be concurrently active. Activity executions may access and modify data included in a case packet. Each process instance has a local copy of the case packet.

As used herein, the term “service” refers broadly to any entity invoked during the execution of a process or function, including human entities, automated entities, internal entities and external entities, independent of the technology that is used to deliver the service. A service may be composed of a single atomic activity to be executed by a human or automated resource. Alternatively, a directed graph that is composed of a combination of work nodes and decisions may be referred to as a service. The term “service” permits a convenient reference by name to a specific graph of activities and decisions without re-iterating these individual components. In this way, the series of activities may be invoked by referring to the service instead of the component sequence of tasks. The introduction of services enables a single definition to be re-used multiple times within the same process or in multiple processes. Thus a service may be used multiple times by a given process or by more than one process.

In the embodiment illustrated in FIG. 3, graph 40 models an expense approval process. The process begins in start node 42 with the requester. The case packet data for the expense approval process may include, for example, the identity of the requester, the expense amount, the reasons, and the names of the individuals that should evaluate the request. Once the process is initiated, the requester is notified in work node 44. Work node 44 may invoke another service for notification. For example, notification may be performed by the service send_email. Upon invocation of the send_email service, an email is sent to the requester with notification that the process has begun. The process loops among the list of individuals until either all of the approves approve the expense request or one of the approvers rejects the expense request (nodes 46-58). (Join 46 is an OR join that fires whenever any input fires.) The final decision is reported to the requester in work node 56 before the process terminates at completion node 58.

At run time, when a work node is executed, a work item is dispatched to internal or external resources (e.g., an employee, a computer system within the domain of service provider 10, or an application operated by another business entity). The appropriate resources may be selected by a resource executive based upon business logic that may be included as part of the process definition, work node definition, or system configuration; alternatively, resources may be determined by contacting a resource broker. A work item typically is identified by a name (e.g., approve_request) and by a set of data items (e.g., the name of the requester, the purpose of the request, and the amount of money required to fulfill the request). The work may be dispatched in several different ways. For example, the work item may be inserted into a resource work list, in which case resources log into the system to retrieve work items. In other approaches, a process automation system sends work items to the selected resources, in which case resources are presented with a set of work items to be performed when the resources access their work lists. A resource may select one or more items from the work list, execute the selected items, and return the result to the process automation system.

Referring to FIG. 4, in one embodiment, service provider 10 (FIG. 1) includes a business process platform 60 that supports execution of internal electronic interactions 62 within a domain of service provider 10 and manages external electronic interactions 64, 66, 68 (e.g., business-to-business and business-to-customer interactions) between service provider 10 and a plurality of external entities 24, 12, 14. Business process platform 60 includes a web server 70, an application server 72, a work flow management system (WfMS) 74, an integration platform (or integrator) 76, and a plurality of back-end applications 78, 80, 82, 84, 86. Web server 70 is configured to accept and serve static HTTP requests and redirect dynamic requests. Application server 72 is configured to process non-static HTTP requests. In some embodiments, application server 72 may offer an implementation of the Java J2EE (Java 2 Platform, Enterprise Edition) specification and provide features supporting reliable, personalized, multi-device delivery of business services. Application server 72 also may provide XML (eXtensible Markup Language) document management capabilities. Workflow management system 74 is configured to automate the execution of business processes within and across the domain of service provider 10. Workflow management system 74 also may provide some level of business process monitoring and analysis functionality. Integration platform 76 (e.g., a message broker) is configured to hide heterogeneity of back-end applications 78-86 and to provide a homogeneous model and protocol for accessing heterogeneous applications. Back-end applications 78-86 support specific, vertical functionalities, such as procurement, inventory management, or meeting room reservation. Business process platform 60 also may include other middleware applications. For example, business process platform 60 may include Web Services Platforms (WSPs) that allow the development, brokering and delivery of Web Services (WS) and support business-to-business standards and protocols, such as RosettaNet, UDI (Uniform Driver Interface) and ebXML (electronic business XML).

In operation, business process platform 60 executes one or more business processes each of which invokes a respective set of one or more services. The invocation of a service may involve sending a single message, or may consist of several message exchanges. For example, when accessing an e-publishing service, clients may upload a document, then select a template, then compose the booklet, and finally print the booklet. A set of messages between a client and a service is referred to herein as a “conversation.” Each interaction between a client and a service, and between the service and the set of services it invokes, occurs in the context of a conversation. Examples of conversation types include requests for quotes and purchases of goods. The context of an active conversation may be defined by one or more measurable attributes selected from the following:

a conversation type identifier (e.g., RosettaNet PIP 314)

a conversation instance identifier

partners involved in the conversation

conversation initiation and completion time

deadlines and other quality of service parameters

every message exchanged during the conversation, including:

message unique identifier

message source

message target

message parameters

message timestamps (denoting, e.g., when a message was sent and/or received)

indication of whether the message is in reply to some other message

an indication of whether the conversation is executed with the context of another conversation (e.g., a conversation between providers executed in the context of a conversation between a provider and a customer)

For every service executed by service provider 10, a conversation audit log containing information about the context and context changes that occur during a conversation is stored. The conversation audit log data may be collected by one or more of the components 70-86 of business process platform 60 and stored in respective databases. Any preliminary analysis data generated by the components 70-86 of business process platform 60 also is stored in respective databases.

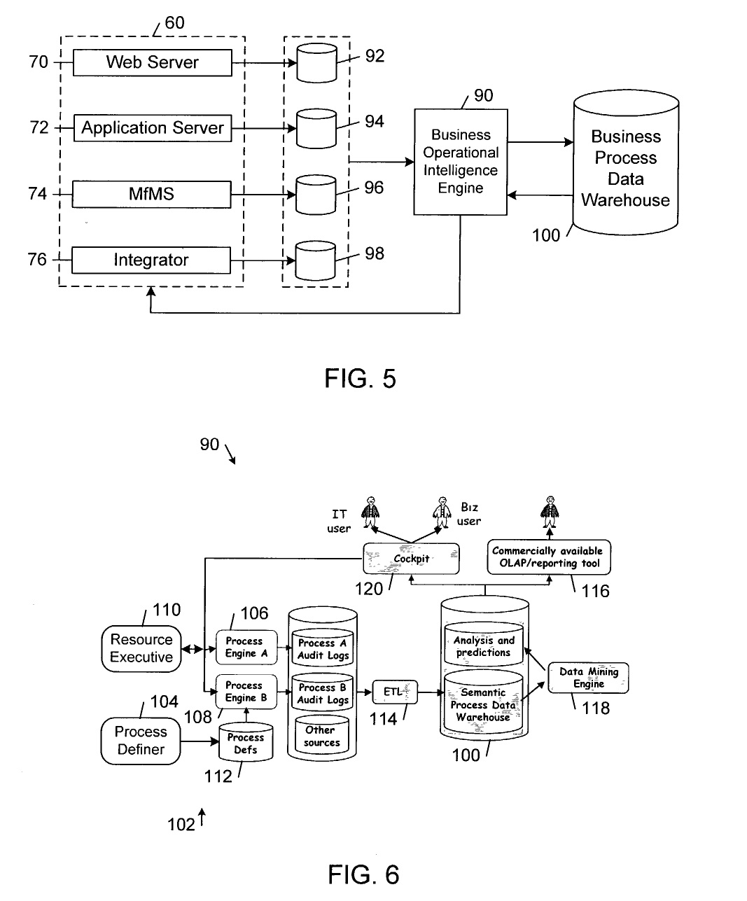

As shown in FIG. 5, in one embodiment, service provider 10 also includes a business operational intelligence engine 90 that supports the definition, execution, and tracking of business processes. Business operational intelligence engine 90 may be used to support administrative and production processes as well as to implement complex web services, delivered by composing existing processes and services according to some process logic. Business operational intelligence engine 90 has the ability to log information about the business processes it supports, including, for example, the start and completion time of each activity, its input and output data, the resource that executed it, as well as every event (message) sent or received by a process. The audit log data maintained by the components of business process platform 60 may be stored in respective databases 92, 94, 96, 98. As explained in detail below, business operational intelligence engine 90 is configured to build a business process data warehouse 100 by extracting the process execution data from databases 92-98. The business operational intelligence engine 90 allows high-level analysis information about process executions to be delivered to users, such as business and IT (Information Technology) analysts, in a way that is easy to access and to consume. In particular, business operational intelligence engine 90 enables users to visualize a business process with a focus on a user-selected process entity and summarized in terms of a user-selected statistic presented across a user-selected perspective corresponding to an attribute dimension of the user-selected process entity. Business operational intelligence engine 90 enables users to analyze the information stored in business process data warehouse 100 to reveal problems and inefficiencies in process executions and identify solutions in order to improve process execution quality, both as perceived by external users in terms of better and faster processes (external quality), and as perceived by service providers in terms of lower operating cost (internal quality). Business operational intelligence engine 90 also allows critical issues to be identified and highlighted in a timely fashion, and allows alerts to be delivered to a variety of applications and devices. In addition, business operational intelligence engine 90 allows processes to be managed dynamically by providing feedback to process engines that optimizes process executions. In addition, information on active processes may be used to monitor active process instances and to provide alerts of predicted and actual quality degradations.

Referring to FIG. 6, in one embodiment, business operational intelligence engine 90 includes a business process automation tool 102 (e.g., an HP Process Manager, available from Hewlett-Packard Company of Palo Alto, Calif., U.S.A.) comprising a process definer 104, one or more process engines 106, 108, and a resource executive 110. Process definer 104 defines processes as a collection of nodes, services, and input and output parameters. The process definitions are stored in a database 112. Database 112 may contain, for example, a process definition that includes a start node, a completion node, work nodes, route nodes, and services to be invoked by the process. A process definition also includes an indication of the way in which the nodes are interconnected. Process engines 106, 108 execute processes by scheduling nodes to be activated. When a work node is activated, process engines 106, 108 retrieve the associated service definition and resource assignment rule. The resource assignment rule is communicated to the resource executive 110, which identifies one or more resources (e.g., a specific vendor, employee, or piece of equipment) that should execute the service. During execution of processes, process engines 106, 108 step through the process definitions to determine which activities should be performed next, and use the resource executive 110 to assign a resource (or resources) to the activities. Process engines 106, 108 send activity requests and any data needed to perform the activities to the resources identified by the resource executive 110. When the activity is completed, the process engines 106, 108 refer to the process definitions to determine the next nodes to be activated.

An extract, transfer, and load (ETL) application 114 collects data from the audit logs and loads the data into business process data warehouse 100. ETL application 114 performs conventional warehousing functions, such as data cleaning, and formats the process execution data into a predefined record format. Additional details relating to the structure and operation of the business process data warehouse 100 and ETL application 114 may be obtained from U.S. patent application No. 09/860,230, filed May 17, 2001, by Fabio Casati et al. and entitled “Method of Identifying and Analyzing Business Processes from Workflow Audit Files,” and Angela Bonifati et al., “Warehousing Workflow Data: Challenges and Opportunities,” Proceedings of VLDB'01, Rome, Italy (September 2001), each of which is incorporated herein by reference. Data in the business process data warehouse 100 may be accessed directly with a commercial reporting tool 116 (e.g., Crystal Reports, available from Crystal Decisions, Inc. of Palo Alto, Calif., U.S.A., and Oracle Discoverer available from Oracle Corporation of Redwood Shores, Calif.). In addition, a data mining tool 118 may apply data mining techniques on top of business process data warehouse 100 to assist analysts in identifying the causes of high and low-quality executions and deriving prediction models that may be used at run-time to predict process execution quality for running processes.

Business operational intelligence engine 90 also includes a business process cockpit (BPC) 120 that enables a user to investigate a business process by supporting real-time monitoring, analysis, management, and optimization of business processes running on top of the business process automation tool 102. Business process cockpit 120 provides a graphical user interface through which users may apply data warehousing and data mining techniques to business process execution data. As explained in detail below, business process cockpit 120 allows business and IT users to analyze data contained in business process data warehouse 100 according to multiple perspectives. The business process cockpit 120 is designed to make it easy for (non-technical) users to define a wide range of queries and, more generally, of analysis and quality criteria, without writing any code. The information is presented in an intuitive and direct format, so that users may easily and immediately get the information they need. In addition, business process cockpit 120 is configurable according to the needs and preferences of different users. Business process cockpit 120 also monitors processes, services, resources, and other process-related entities, and inform users of actual or foreseen quality degradation. Business process cockpit 120 also may send notifications to users on the medium of their choice. Business process cockpit 120 is operable to manage running processes by tuning process and system configuration parameters (such as the process priority) and by notifying events to processes.

As explained in detail below, business operational intelligence engine 90 enables service provider 10 to improve the quality of business processes implemented by workflow management system 74 by automatically extracting from the log files of the workflow management system 74 knowledge with which process designers may understand the real time execution of decision points in the business processes.

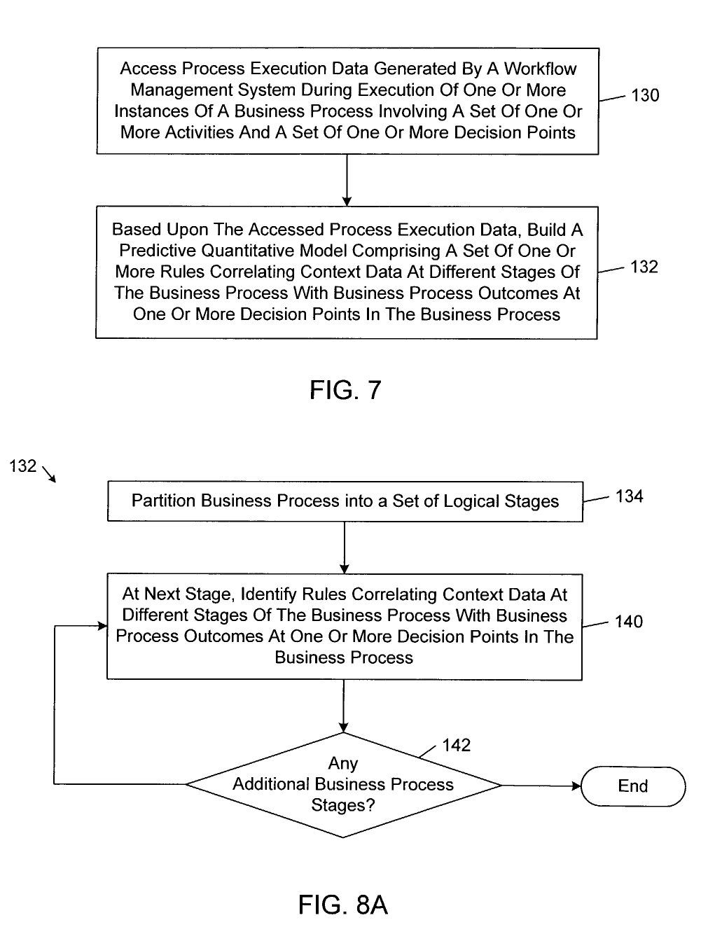

Referring to FIGS. 7, 8A, 8B and 9, and initially to FIG. 7, in one embodiment, a user may operate business operational intelligence engine 90 to analyze decision points in a business process as follows. Initially, business operational intelligence engine 90 accesses process execution data generated by workflow management system 74 during execution of one or more instances of a business process involving a set of one or more activities and a set of one or more decision points (step 130). Based upon the accessed process execution data, business operational intelligence engine 90 builds a predictive quantitative model comprising a set of one or more rules correlating context data at different stages of the business process with business process outcomes at one or more decision points in the business process (step 132).

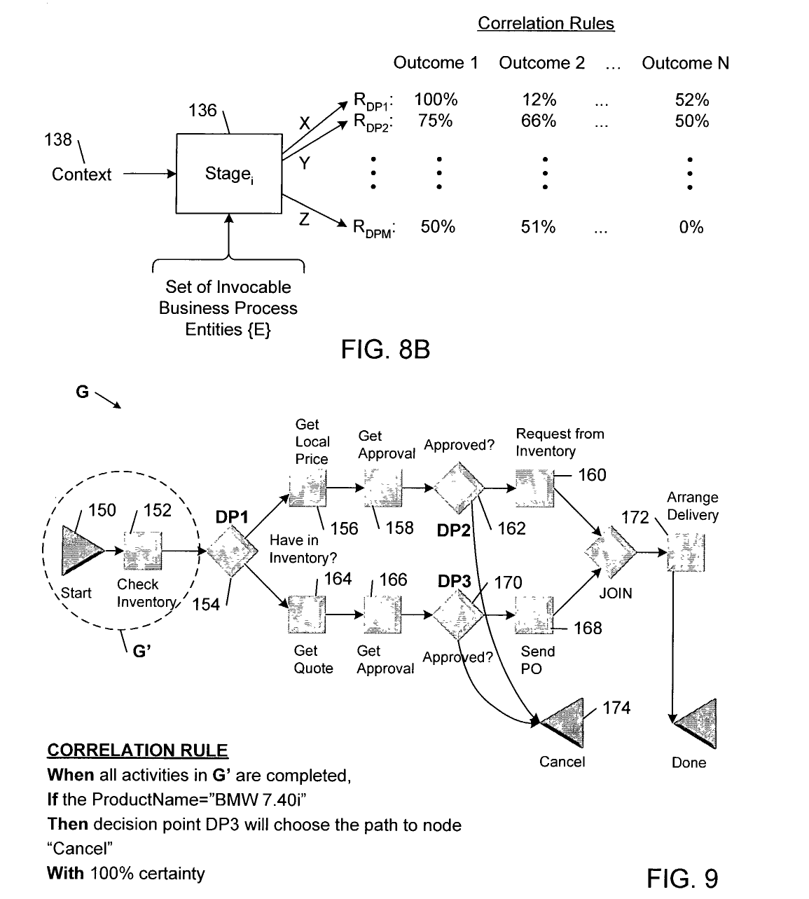

Referring back to FIGS. 8A and 8B, in one embodiment, the predictive quantitative model is built by partitioning the business process into a set of logical stages (step 134; FIG. 8A). Each logical stage may encompass one or more nodes in the business process definition. In one embodiment, conventional data mining techniques are used to partition the contexts. The problem of identifying the appropriate partition is similar to that of defining the appropriate depth of a decision tree. In general, finer partitions allow the identification of more specific context and, therefore, of more accurate ratings for that specific context subspace. Narrow partitions for which there is only limited data available, however, may be sensitive to noise, which may produce erroneous results.

After the business process has been partitioned into a set of logical stages (step 134; FIG. 8A), rules are generated at the current logical stage 136 for predicting outcomes of one or more decision points in the business process based upon context data 138 available at the current logical stage 136 (step 140; FIG. 8A). Conventional data mining technologies (e.g., classifiers, clustering, association rule generation, decision trees, and Bayesian networks) may be used to identify correlation rules. This process is repeated for each stage of the business process (step 142; FIG. 8A). As shown in FIG. 8B, the correlation rules (R_{DP1}, R_{DP2}, . . . R_{DPM}) may be expressed in terms of a set of probabilities for each possible outcome (Outcome 1, Outcome 2, . . . , Outcome N) at each decision point (DP1, DP2, . . . , DPM) in the business process conditioned on completion of all activities up to a given stage (Stage,) of the business process and a given context data value (X, Y, Z).

Referring to FIG. 9, in one illustrative implementation, a product purchase request process may be defined in accordance with the directed graph G. An instance of this process is initiated when an employee submits a request for the purchase of a product (step 150). The process first checks whether the product is already in the local inventory of the organization (step 152). If it is in the inventory (step 154), then the process follows the sequence of activities for: retrieving the price of the product (step 156), getting the approval of the employee who initiated the purchase request (step 158), and requesting the product from the inventory upon the approval of the employee (steps 160, 162). If the product is not in the inventory (step 154), then a product quote is requested from a vendor (step 164), the employee's manager is asked for approval on the received quote (step 166), and a purchase order is submitted to the vendor upon approval (steps 168, 170). After following one of the two possible paths, delivery of the product to the employee is arranged (step 172). The set of activities above will be followed when employee or the manager gives the required approval for the local product price or vendor's product quote. In case of rejection by the employee or the manager, the process ends at a different node, marked by “Cancel” (step 174).

As explained above, business operational intelligence engine 90 may extract from WfMS logs generated during execution of one or more instances of the product purchase request process of FIG. 9 knowledge about which paths may be followed at decision points (DP1 , DP2, DP3) in a process definition. After correlations between context data at different stages of the business process with business process outcomes at one or more decision points in the business process have been found, they may be presented to process designers in the following format:

Given a graph G that represents the process definition of a WfMS process, after the activities in a subset G′ of the original graph have been completed and for a certain set of values for process variables and time-related data, we can state with X% certainty that a particular path P would be chosen at a given decision point DP.

Using the correlation rule illustrated in FIG. 9, for example, a process designer may decide to reshape the process definition or issue a warning statement for the users of the WfMS so that users do not submit funny requests, such as purchasing a luxury car for company use. In other examples, this tool may provide valuable information to process designers about the outcomes of all decision points, which in turn gives the outcome of the whole process. For example, a process designer may learn that submitting purchase orders to a certain vendor on Wednesdays is not a good idea, because that vendor handles all orders periodically on Tuesdays. A simple modification in the process definition may cause the purchase orders to be submitted to a different vendor on Wednesdays (maybe also Thursdays).

Among the factors that affect the outcomes of decision points (where “outcome” refers to the path that is chosen by the decision point) are the following:

Start time of the process instance and individual activities within the process: for example, a vendor might be processing all orders on Tuesdays. Thus, if we submit an order on Wednesday as a part of a process, that order may take a longer time than another order that was sent on Monday.

Resources involved in activities of the process: some resources (e.g., some employees who are in charge of handling certain types of requests) may take longer time to perform certain activities, compared to other resources. For example, one employee may be working faster than the others, and the processes, in which that fast employee is involved, may proceed faster.

Duration of the time that passed since the start of the process instance, or duration since the start of a particular activity: for example, if we did not hear from a vendor for ten days after sending a purchase order, that might mean that something is wrong (may be the order was lost somewhere or cannot be completed for some reason).

Data variables:

Values of business process variables: most WfMS allow process instance level variables to be used in the definition of business processes. Some of those variables may be passed into individual activities, and outputs of those activities may be mapped into some other process level variables. Values of process variables after a particular activity in the process definition may significantly affect the path that will be chosen later at a decision point. For example, if an organization is trying to reduce the costs in certain fields, purchase orders for certain products may be rejected by managers. Therefore, a variable that contains the name or identifier number of a product among the process level variables can tell us whether a request would be rejected before even checking the inventory in the process definition of FIG. 9.

Updates of variables: the change of process level variables at certain activities may be an indicator of which path will be selected at a later decision point in the process definition. For example, an approval might require that the manager should enter an approval number. Thus, a change in the value of a process level variable that contains the approval number (i.e., from null to some other numeric value) may indicate that the path that involves the submission of a purchase order will be taken in the process definition of FIG. 9.

Length or cardinality of process variable values: as an example, sometimes an organization may require that at most five products can be ordered within one request. If a variable that holds the list of requested items contains more than five elements, then the request will definitely be rejected. In order to find out that such a request will be rejected, the process does not have to proceed until the decision point where the manager's approval is examined. It is possible to guess it at a very early stage of the process instance execution.

Additional details relating to the structure and operation of business operational intelligence engine 90 and business process cockpit 120 may be obtained from U.S. patent application Ser. No. ______, filed ______, by Fabio Casati et al., and entitled “Investigating Business Processes” [Attorney Docket No. 10019712-1].

Other embodiments are within the scope of the claims. For example, the above-described decision point analysis techniques also may be applied to WfMS process definitions that allow multiple paths of the process definition to be executed in parallel.

The systems and methods described herein are not limited to any particular hardware or software configuration, but rather they may be implemented in any computing or processing environment, including in digital electronic circuitry or in computer hardware, firmware, or software. In general, the components of the business operational intelligence engine may be implemented, in part, in a computer process product tangibly embodied in a machine-readable storage device for execution by a computer processor. In some embodiments, these systems preferably are implemented in a high level procedural or object oriented processing language; however, the algorithms may be implemented in assembly or machine language, if desired. In any case, the processing language may be a compiled or interpreted language. The methods described herein may be performed by a computer processor executing instructions organized, for example, into process modules to carry out these methods by operating on input data and generating output. Suitable processors include, for example, both general and special purpose microprocessors. Generally, a processor receives instructions and data from a read-only memory and/or a random access memory. Storage devices suitable for tangibly embodying computer process instructions include all forms of non-volatile memory, including, for example, semiconductor memory devices, such as EPROM, EEPROM, and flash memory devices; magnetic disks such as internal hard disks and removable disks; magneto-optical disks; and CD-ROM. Any of the foregoing technologies may be supplemented by or incorporated in specially designed ASICs (application-specific integrated circuits).

What is claimed is:

1. A method of analyzing decision points in a business process, comprising:
accessing process execution data generated by a workflow management system during execution of one or more instances of a business process involving a set of one or more activities and a set of one or more decision points; and
based upon the accessed process execution data, building a predictive quantitative model comprising a set of one or more rules correlating context data at different stages of the business process with business process outcomes at one or more decision points in the business process.

2. The method of claim 1, wherein building the predictive quantitative model comprises partitioning the business process into a set of logical stages.

3. The method of claim 2, wherein each logical stage comprises a set of one or more nodes in a definition of the business process.

4. The method of claim 3, further comprising searching for correlations between context data and decision points at each logical stage.

5. The method of claim 1, wherein a correlation rule specifies an outcome probability at a decision point conditioned on completion of all activities up to a given stage of the business process and a given context data value.

6. The method of claim 5, wherein the given context data relates to time information.

7. The method of claim 6, wherein the given context data corresponds to a duration.

8. The method of claim 6, wherein the given context data corresponds to a start time.

9. The method of claim 5, wherein the given context data relates to a business process variable.

10. The method of claim 9, wherein the given context data corresponds to a resource identifier.

11. The method of claim 9, wherein the given context data corresponds to a change in a value assigned to a business process variable.

12. The method of claim 9, wherein the given context data corresponds to a threshold value assigned to a business process variable.

13. The method of claim 1, further comprising presenting one or more correlation rules to a user.

14. A computer program for analyzing decision points in a business process, the computer program residing on a computer-readable medium and comprising computer-readable instructions for causing a computer to:
access process execution data generated by a workflow management system during execution of one or more instances of a business process involving a set of one or more activities and a set of one or more decision points; and
based upon the accessed process execution data, build a predictive quantitative model comprising a set of one or more rules correlating context data at different stages of the business process with business process outcomes at one or more decision points in the business process.

15. A method of analyzing decision points in a business process involving a set of one or more activities and a set of one or more decision points, comprising:
presenting to a user one or more rules correlating context data at different stages of the business process with business process outcomes at one or more decision points in the business process.

16. The method of claim 15, wherein a correlation rule specifies an outcome probability at a decision point conditioned on completion of all activities up to a given stage of the business process and a given context data value.

17. The method of claim 16, wherein the given context data relates to time information.

18. The method of claim 17, wherein the given context data corresponds to a duration.

19. The method of claim 17, wherein the given context data corresponds to a start time.

20. The method of claim 16, wherein the given context data relates to a business process variable.

21. The method of claim 20, wherein the given context data corresponds to a resource identifier.

22. The method of claim 20, wherein the given context data corresponds to a change in a value assigned to a business process variable.

23. The method of claim 20, wherein the given context data corresponds to a threshold value assigned to a business process variable.

24. A system for analyzing decision points in a business process involving a set of one or more activities and a set of one or more decision points, comprising a graphical user interface configured to:
present to a user one or more rules correlating context data at different stages of the business process with business process outcomes at one or more decision points in the business process.
